(19) United States
(12) Patent Application Publication
(10) Pub. No.: US 2024/0283721 A1
(43) Pub. Date: Aug. 22, 2024

(54) PACKET CAPTURE METHOD AND DEVICE THEREFOR

(71) Applicant: Nippon Telegraph and Telephone Corporation, Tokyo (JP)

(72) Inventors: Shuhei Yoshida, Tokyo (JP); Hiroyuki Uzawa, Tokyo (JP); Namiko Ikeda, Tokyo (JP); Saki Hatta, Tokyo (JP); Yusuke Sekihara, Tokyo (JP); Shoko Oteru, Tokyo (JP)

(21) Appl. No.: 18/570,022

(22) PCT Filed: Jun. 23, 2021
(86) PCT No.: PCT/JP2021/023747

§ 371 Date: Dec. 13, 2023

(51) Int. Cl. H04L 43/0823; H04L 41/06

(52) U.S. Cl. CPC H04L 43/0823; H04L 41/06

(57) ABSTRACT

An embodiment packet capture method includes steps of imparting a flag for each data of a received and divided packet, a step of writing the data in a ring buffer, steps of issuing a failure detection trigger when a cumulative value of the number of bytes of the packet within a period of failure detection exceeds a failure detection threshold value, steps of stopping writing to the ring buffer when writing to the ring buffer reaches or exceeds a writing stop address determined on the basis of the failure detection trigger, a step of reading data sequentially from the writing stop address, and steps of outputting a packet capture depending on the result determined based on the flags of the read data.

### CROSS-REFERENCE TO RELATED APPLICATIONS

This application is a national phase entry of PCT Application No. PCT/JP2021/023747, filed on Jun. 23, 2021, which application is hereby incorporated herein by reference.

### TECHNICAL FIELD

The present invention relates to a packet capture method and device thereof used in a network system.

### BACKGROUND

In recent years, traffic has been instantaneously concentrated within extremely short times in data centers, and network failures have occurred. In a network system for transmitting and receiving packets, it is necessary to accurately and efficiently transmit and receive packets even at the time of a network failure.

In particular, as one type of network failure, a microburst causes network delay and packet loss. Therefore, it is necessary to provide a packet capture device capable of analyzing a network failure such as a microburst and receiving a packet.

In a general network failure analysis method, packets of a network in which a failure occurs are captured and which traffic causes the failure is analyzed.

### CITATION LIST

### Patent Literature

PTL 1—International Publication No. 2020/230265
PTL 2—Japanese Patent Application Publication No. 2020-182027

### Non Patent Literature

NPL 1—Akiko Taiki et al., “A Study of Memory Address Management Methods in Packet Buffers,” 2016 General Conference of the Institute of Electronics, Information and Communication Engineers, page 26, 2016.

### SUMMARY

### Technical Problem

However, since a microburst is an instantaneous phenomenon and its occurrence timing cannot be predicted, a memory for storing a large amount of capture data is required. Further, it is difficult to specify a microburst occurrence place from the data.

A method of capturing only packets before and after the occurrence of a microburst to specify the microburst occurrence place has been disclosed (PTL 1). In this method, a failure detection function and a capture function are provided in the same device, packets are sequentially stored in a memory of a ring buffer configuration, and capture is stopped with the failure detection as a trigger. Thus, it is possible to capture not only a packet after the failure detection but also a packet before the detection. Further, by storing one packet for one memory word constituting the ring buffer, the breakage of the packet can be identified.

However, since the packet has a variable length, it is necessary to match a word length to a maximum packet length, which increases a memory capacity used for the ring buffer.

Also, a method of reducing the word length and storing one packet over a plurality of words is disclosed (PTL 2, NPL 1).

However, since a memory in which information (packet length and address) for identifying the breakage of the packet stored in the memory is recorded is separately required, the memory capacity is increased.

In this way, in the related art, it is difficult to suppress a memory capacity and realize a packet capture for packets of a variable length before and after the occurrence of a network failure such as a microburst.

### Solution to Problem

In order to solve the above problem, a packet capture method according to embodiments of the present invention includes a step of receiving a packet; a step of dividing the packet and imparting a flag for each piece of data of the divided packet; a step of writing the data at an address of a ring buffer, a step of accumulating the number of bytes of the packet when the packet is received within a period for detecting a failure; a step of issuing a failure detection trigger when a cumulative value of the number of bytes exceeds a preset failure detection threshold value; a step of determining a writing stop address on the basis of the failure detection trigger; a step of stopping writing to the ring buffer when writing to the ring buffer reaches or exceeds the writing stop address; a step of reading the data in order from the writing stop address; a step of determining a packet capture output on the basis of the flag of the read data; and a step of executing the packet capture output depending on the determination result.

A packet capture device according to embodiments of the present invention includes a packet reception unit; a flag imparting unit which divides a packet received by the packet reception unit and imparts a flag for each piece of data of the divided packet; a packet holding unit having a ring buffer in which the data is written; a failure detection unit which issues a failure detection trigger when a failure is detected in reception of the packet; a capture control unit which stops writing of the data on the basis of the failure detection trigger; and a capture file generation unit which reads the data written in the ring buffer, and outputs the data to a capture file on the basis of the flag imparted to the data.

### Advantageous Effects of Embodiments of the Invention

According to embodiments of the present invention, it is possible to provide a packet capture method and a packet capture device capable of efficiently performing a packet capture before and after an occurrence of a packet failure.

### BRIEF DESCRIPTION OF THE DRAWINGS

FIG. 1 is a block diagram showing a configuration of a packet capture device according to a first embodiment of the present invention.

FIG. 2A is a flowchart diagram for explaining a packet capture method according to the first embodiment of the present invention.

FIG. 2B is a flowchart diagram for explaining a packet capture method according to the first embodiment of the present invention.

FIG. 3A is a flowchart diagram for explaining the packet capture method according to the first embodiment of the present invention.

FIG. 3B is a flowchart diagram for explaining the packet capture method according to the first embodiment of the present invention.

FIG. 3C is a flowchart diagram for explaining the packet capture method according to the first embodiment of the present invention.

FIG. 4 is a diagram for explaining the effects of the packet capture method and device thereof according to the first embodiment of the present invention.

FIG. 5 is a diagram for explaining the effects of the packet capture method and device thereof according to the first embodiment of the present invention.

FIG. 6 is a block diagram showing a configuration of a packet capture device according to a second embodiment of the present invention.

### DETAILED DESCRIPTION OF ILLUSTRATIVE EMBODIMENTS

### First Embodiment

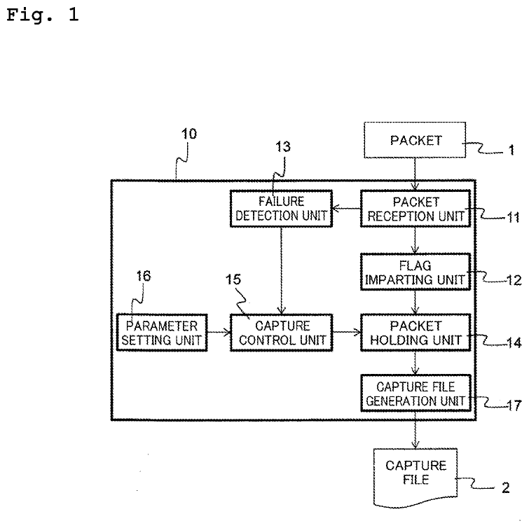

A packet capture method and device thereof according to a first embodiment of the present invention will be described with reference to FIGS. 1 to 5.

### Configuration of Packet Capture Device

The packet capture device 10 according to the present embodiment includes a packet reception unit 11, a flag imparting unit 12, a failure detection unit 13, a packet holding unit 14, a capture control unit 15, a parameter setting unit 16, and a capture file generation unit 17. Each component part of the packet capture device 10 will be described below.

### Packet Reception Unit

The packet reception unit 11 receives packets 1 from an external network.

### Flag Imparting Unit

In the flag imparting unit 12, the packets 1 which are input from the reception packet unit are divided into logical word units of the memory (hereinafter referred to as “ring buffer”) forming the ring buffer of the packet holding unit 14, and a packet head flag is imparted in divided units.

The packet head flag imparts 1 when the divided data (hereinafter referred to as “divided packet data”) includes the packet head, and the packet head flag imparts 0 in other cases.

### Failure Detection Unit

The failure detection unit 13 is a functional unit that detects a failure from a variation in an amount of the packets 1 that are input from the packet reception unit 11. Here, a case of detecting a burst of traffic called a microburst occurring in a time of the order of sub-milliseconds will be described.

The number of bytes of the packets 1 is accumulated at a fixed cycle, it is determined whether it exceeds the preset threshold value, and if so, a microburst is detected.

When a failure is detected, a failure detection trigger is transmitted to the capture control unit 15.

### Packet Holding Unit

In the packet holding unit 14, the packets 1 received by the packet reception unit 11 of ring buffer constitution are sequentially stored in the ring buffer, and the oldest packet data is overwritten when the memory capacity exceeds the memory capacity.

At this time, the packet data is stored in a predetermined length unit, and when the packet data is not stored in one word, the packet data is stored over the next word.

In addition, for a word in which the head data of each packet is stored, 1 is set for an SOP flag indicating the head of the packet, and for other words, 0 is set for the SOP flag.

The packet holding unit 14 is provided with a memory of a ring buffer constitution, and the packet data with the packet head flag input from the flag imparting unit 12 is successively written in the ring buffer.

When the packet data is completely written to the end of the ring buffer, the writing address is returned to the head of the ring buffer. Thereafter, by repeating the same writing operation, a predetermined amount of the most recently received packets can be held in the ring buffer.

### Capture Control Unit

The capture control unit 15 performs control to hold packets in a period before and after the failure detection.

The capture control unit 15 controls the writing of packet data to the ring buffer in the packet holding unit 14. As described above, the packet holding unit 14 writes the packet data which is input from the flag imparting unit 12 sequentially in a normal state.

When a failure detection trigger is received from the failure detection unit 13, the packet data writing operation to the ring buffer is controlled so that the packet data before and after the received packet data is held at a preset ratio of a pre-failure detection holding region to a post-failure detection holding region (hereinafter referred to as “address holding ratio”). Here, the “pre-failure detection holding region” refers to an address region for holding the packet data by going back in time series from the time when the failure detection trigger is received, and the “post-failure detection holding region” refers to an address region for holding the packet data after the time when the failure detection trigger is received.

Specifically, an address traced back by the pre-failure detection holding region is calculated from a writing address at the time of receiving the failure detection trigger to a side where an old packet is held in time series, and the address is set as a “writing stop address”.

The capture control unit 15 writes the packet data newly input from the flag imparting unit 12 until the write destination address of the packet data in the packet holding unit 14 reaches the writing stop address, and stops the write when the write destination address reaches the writing stop address.

At this time, the packet data is written in units of packets. As a result, the end of the address at the end of the packet does not coincide with the end of the writing stop address, and may exceed the writing stop address. In this case, the writing is stopped when exceeding the writing stop address.

Further, when the writing is stopped, there is a case where the writing is stopped in a state in which a part of the old packet data is overwritten. In this case, output of the overwritten part of old packet data (hereinafter also referred to as “damaged data”) is avoided by a file output procedure to be described later.

Since there is a tool in which the capture file including the damaged data does not open the file among the tools for browsing the capture file, it is desirable that the damaged data be not written.

### Parameter Setting Unit

In the parameter setting unit 16, a threshold value used in the failure detection unit 13, and a ratio (address holding ratio) between a pre-failure detection holding region and a post-failure detection holding region used in the capture control unit 15 are set in advance as parameters from the outside.

### Capture File Generation Unit

The capture file generation unit 17 outputs the packet held in the packet holding unit 14 as capture data such as a PCAP format.

Specifically, after the packets held in the ring buffer are recorded in the memory of the capture file generation unit 17 in time series order, packet data are read from the memory and output to the capture file.

Here, when the capture control unit 15 stops writing, the packet data is read out in order from the address next to the address where the packet data is written last, and output to the capture file (converted into a capture file).

In this capture file formation, if the head flag imparted to each divided packet data is 0, the data of the next address is read out without being output to the file.

When the packet head flag is 1, the data is selected as data to be converted into a capture file, and a series of selected data is output to the capture file as data constituting one packet. For example, after detecting 1 of the packet head flags, the packet data may be read until detecting 1 of the packet head flags next, and the data may be used as data constituting one packet.

### Packet Capture Method

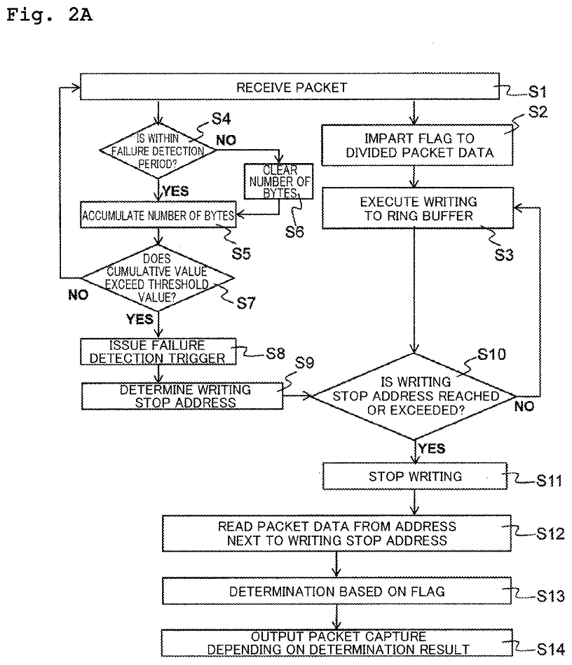

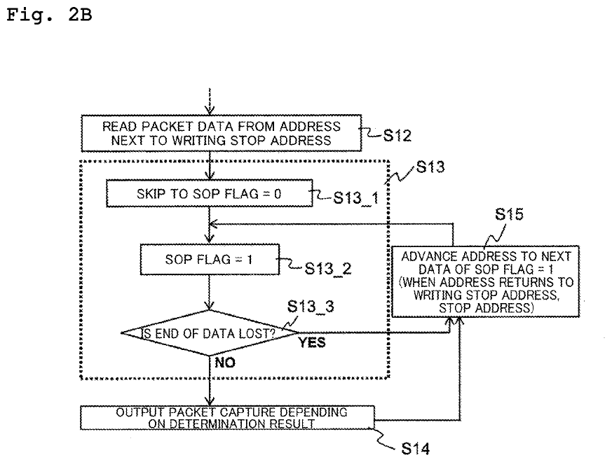

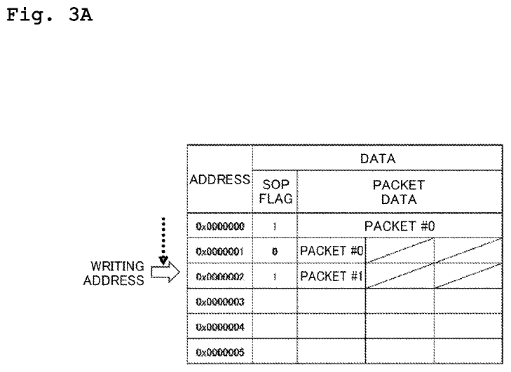

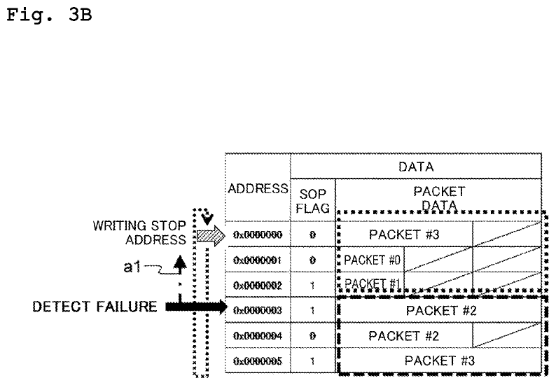

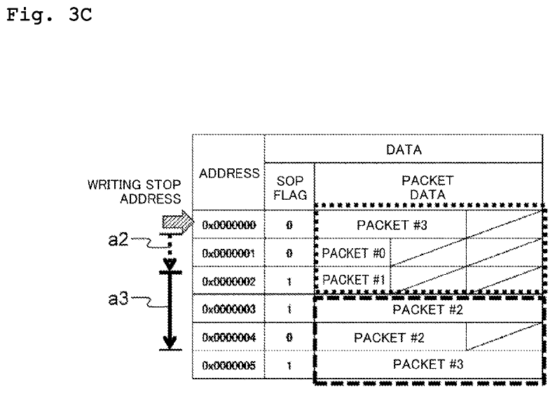

A packet capture method according to the embodiment of the present invention will be described with reference to FIGS. 2A to 3C.

First, a packet 1 is received (S1).

Next, the received packet 1 is divided by the logical word unit of the ring buffer, and a packet head flag is imparted to each divided packet data (S2). The packet head flag imparts 1 when the divided packet data includes the packet head, and imparts 0 in other cases.

Then, divided packet data are written in each address of the ring buffer (S3).

On the other hand, if the packet reception time is within a period for detecting a failure, the number of bytes of the packet is accumulated (integrated) (S4 to S5).

If the packet reception time is not within the period for detecting the failure, the number of bytes of the packet is accumulated (integrated) after the number of bytes is cleared once (S6).

Next, a failure (microburst) is determined by the cumulative value of the number of bytes (S7). When the cumulative value of the number of bytes exceeds a set threshold value, a failure detection trigger is issued (S8).

When the cumulative value of the number of bytes is equal to or less than the threshold value, the failure detection trigger is not issued, and packet reception is continued (S1).

Next, when the failure detection trigger is issued, an address for stopping writing (hereinafter, “writing stop address”) is determined (S9). Here, the writing stop address is calculated by going back in time series at the address of the ring buffer from the writing address at the time point when the failure detection trigger is issued, on the basis of a preset address holding ratio.

Specifically, the writing stop address is calculated backward by the address of the pre-failure detection holding region in a direction in which the old packet data is held (written) at the address of the ring buffer, from the writing address at the time when the failure detection trigger is issued, on the basis of a preset address holding ratio.

When the write destination address of the packet data in the ring buffer reaches the writing stop address or exceeds the writing stop address, the writing of the packet data is stopped (S10 to S11).

When the failure detection trigger is not issued, and when the writing stop address is reached and not exceeded, the reception packet is continuously written in the ring packet (S3). Thereafter, the packet data is continuously transferred to the next address at the end of the written packet data, and the packet reception is continued.

Next, in order to output (capture file formation) to a capture file, packet data are sequentially read from the writing stop address (S12).

Next, it is determined whether to output the packet data to a capture file on the basis of the head flag imparted to each divided packet data (S13).

Finally, a series of data selected depending on the determination result is output (converted into a capture file) as data constituting one packet to the capture file (S13).

For example, if the head flag imparted to each divided packet data is 0 in the capture file, the data of the next address is read out without outputting the data to the file.

If the packet head flag is 1, the packet data are read until the packet head flag becomes 0 next, and the data whose head flag is 1 are output to the capture file as data constituting one packet.

Here, although the example in which “0” and “1” are used as the head flags imparted to the respective divided packet data is shown, the present invention is not limited to this example, and any predetermined value may be used.

In the determination (S13) of the capture file output, the byte length of each packet data can be taken into consideration together with the packet head flag.

For example, as shown in FIG. 2B, the packet data is read from the address next to the writing stop address, and the packet data is skipped until the packet head flag is 0 (S13_1).

When the packet head flag is 1, in a case where the end of the read packet data is not lost on the basis of the byte length of the packet data, the packet data is selected as data to be captured by the packet. When the end of the packet data is lost, the packet data is not selected as data to be captured by the packet. (S13_2, S13_3).

The selected series of data are output to a capture file as data constituting one packet (S14). The read address is advanced until data of the next packet head flag is 1. However, when the writing stop address is returned as a result of the advancement, capture file output processing is stopped (S15). Also, when the end of the read packet data is lost (S13_3), similarly, the read address is advanced until data of the next packet head flag is 1 (S15).

Thereafter, the packet is received and the above-mentioned steps are continued.

In this way, even when the failure is detected and writing to the ring buffer is stopped, even in a case where a part of old packet data is stopped in an overwritten state, the packet data can be output to the capture file without outputting the damaged data to the capture file.

An example of executing the capture file processing by the packet capture method according to the present embodiment will be described with reference to FIGS. 3A to 3C.

FIGS. 3A and 3B show an example of a write mode to a packet storage memory (ring buffer) having a ring buffer configuration. Here, when the packet data is written from the top address “0x0000000” of the ring buffer to the end address “0x0000005” of the ring buffer, the writing address is returned to the head address of the ring buffer “0x0000000”. Thereafter, the same writing operation is repeated. Here, the dotted line arrows in the drawing indicate a direction in which data is written.

The packet data read from the ring buffer is written in the memory of the capture data generation unit. FIG. 3C shows an example of a mode of reading from the memory of the capture data generation unit.

First, packets #0 and #1 are written into the ring buffer. Since the packet #0 has a long byte length, it is written to addresses “0x0000000” to “0x0000001” across two lines (FIG. 3A).

Here, since the address “0x0000000” includes the head of packet #0, the SOP flag becomes 1. Also, the SOP flag becomes 0 at the address “0x0000001” on the second line.

Subsequently, packet #1 is written to address “0x0000002” (indicated by a white arrow in the drawing).

Next, packet #2 and packet #3 are written after address “0x0000003” (FIG. 3B).

Here, packet #2 is written to addresses “0x0000003” to “0x0000004”, the SOP flag becomes 1 at “0x0000003” and the SOP flag becomes 0 at “0x0000004”.

Also, packet #3 is written to address “0x0000005” and then written back to address “0x0000000”. Therefore, the SOP flag becomes 1 at “0x0000005”, and the SOP flag becomes 0 at “0x0000000”.

At this time, when a failure is detected at address “0x0000003” (indicated by the black arrow in the drawing), the writing is stopped in the memory of the capture data generation unit.

When the address holding ratio is set to 50%/50%, the addresses “0x0000000” to “0x0000002” before the address “0x0000003” are set as the pre-failure detection holding region. Also, the addresses “0x0000003” to “0x0000005” after the address “0x0000003” are set as the post-failure detection holding regions.

Also, the writing stop address is calculated retroactively by the address of the pre-failure detection holding region from the writing address “0x0000003” when the failure detection trigger is issued, in the direction in which the old packet data is held (written) at the ring buffer address (arrow a1 in the drawing), on the basis of the address holding ratio (50%/50%). As a result, the address “0x0000000” is set as the writing stop address (diagonal arrow in the drawing).

Next, in the memory of the capture data generation unit, the capture file is not executed for the address whose SOP flag is 0 from the writing stop address, but conversion into the capture file is executed from the address whose SOP flag is 1 (FIG. 3C).

Here, data at addresses 0x0000000 to 0x0000001 whose SOP flag is 0 is not converted to a capture file (dashed arrow a2 in the drawing), and a capture file is executed from the data of address “0x0000002” where the SOP flag is 1 (solid arrow a3 in the drawing).

Here, the data of address “0x0000004” has an SOP flag of 0, but is determined to belong to the previous packet #2 from the byte length of the separately recorded packet #2, and is converted into a capture file.

Also, the data of address “0x0000005” has an SOP flag of 1, but it is determined that packet #3 is incomplete (the end is lost) from the byte length of the separately recorded packet #3, and is not converted into a capture file.

In this way, by determining by the SOP flag and converting into a capture file, it is possible to avoid conversion into a capture file of data damaged by overwriting of the ring buffer (data of packet #0 in this case).

As described above, according to the packet capture method and device thereof according to the present embodiment, even if the received packet is a variable length packet, only the packet before and after the occurrence of a failure can be efficiently converted into a capture file.

### Effects

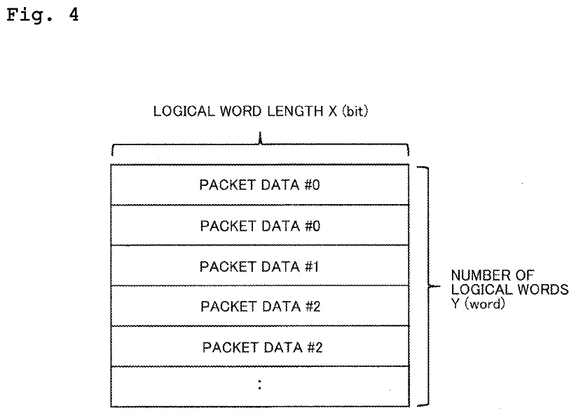

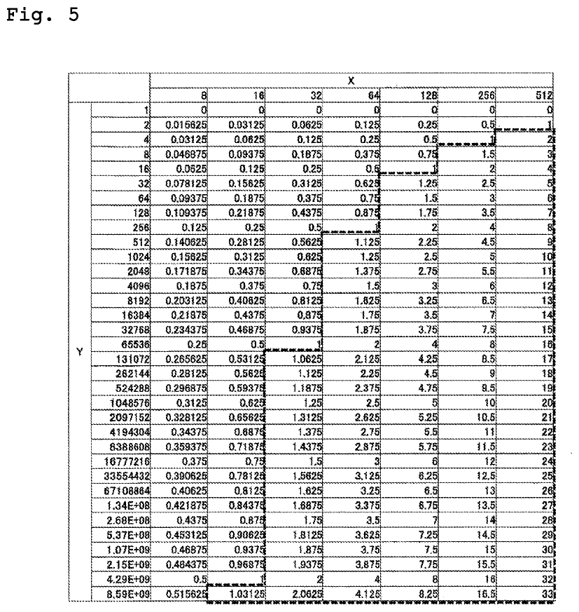

Effects of the packet capture method and device thereof according to the present embodiment will be described with reference to FIGS. 4 and 5.

As an example of the configuration of the memory for writing the packet data, as shown in FIG. 4, the logical word length is set as X (unit: Bit) and the number of logical words is set as Y (unit: Word).

In a conventional method, an amount of data D₀ required to be held (recorded) when adding the packet data is expressed by Equation (1).

$$\begin{matrix}Equation ( 1 ) & \\ {D}_{0} = {log}_{2} Y \times \frac{X \times Y}{{P}_{len \_ min}} & ( 1 )\end{matrix}$$

Here, P_{len_min} is the shortest packet length. A first term in Equation (1) indicates the address bit width, and a second term indicates the number of packets.

In this embodiment, an amount of data D₁ required to be held (recorded) when adding packet data is expressed by Equation (2).

$$\begin{matrix}Equation ( 2 ) & \\ {D}_{1} = 1 \times Y & ( 2 )\end{matrix}$$

Here, the first term in Equation (2) indicates the number of bits necessary for the packet head flag, and the second term indicates the number of logical words.

FIG. 5 shows a ratio (D0/D1) of the amount of data D0 and D1 calculated using Equations (1) and (2). Here, P_{len_min} was calculated as 512 bits. In FIG. 5, D0/D1 becomes 1 or more in a dotted line region, and the amount of data required to be held (recorded) when adding the packet data is small.

In this way, the packet capture method and device thereof according to the present embodiment have the effect in the region in which the logical word length X and the number of logical words Y are large.

According to the packet capture method and device thereof according to the present embodiment, even if a received packet is a variable length packet, only packets before and after the occurrence of a failure can be efficiently converted into capture files.

Therefore, according to the packet capture method and device according to the present embodiment, packet capture can be realized, by suppressing a memory capacity for a variable length packet before and after the occurrence of a network failure.

### Second Embodiment

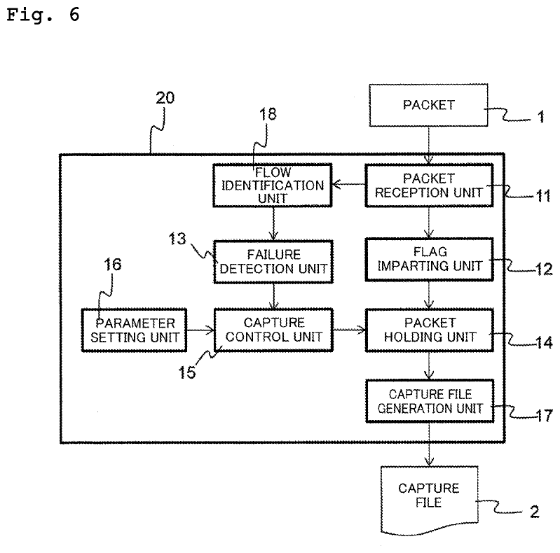

A packet capture method and device thereof according to a second embodiment of the present invention will be described with reference to FIG. 6.

### Configuration of Packet Capture Device

As shown in FIG. 6, a packet capture device 20 according to the present embodiment includes a flow identification unit 18 in the front stage of the failure detection unit 13, in addition to the configuration of the first embodiment.

This embodiment differs in that a failure can be detected for each flow, by installing the flow identification unit 18 in the front stage of the failure detection unit 13.

In the first embodiment, failure detection is executed for all the received packets 1 regardless of the flow. As a result, the entire traffic does not rapidly increase, and when a rapid traffic increase occurs in units of flow, a failure cannot be detected.

On the other hand, in the packet capture device 20 according to the present embodiment, by determining the threshold value in which the number of bytes is accumulated in units of flow, it is possible to detect failures in flow units that cannot be detected when observing the entire traffic.

In the packet capture method and device thereof according to the present embodiment, the flow is identified before the failure detection in the first embodiment. As a result, the failure can be detected in units of flow. Configuration and effect except for this is identical to the first embodiment.

In the embodiments of the present invention, an example of the structure, dimensions, materials, etc. of each component has been shown in the configuration, method, and the like of the packet capture device, but the present invention is not limited thereto. Anything may be used as long as it exhibits the function of the packet capture device and produces an effect.

### INDUSTRIAL APPLICABILITY

Embodiments of the present invention relate to a packet capture device and method thereof, and can be applied to network systems that transmit and receive packets.

### REFERENCE SIGNS LIST

10 Packet capture device
11 Packet reception unit
12 Flag imparting unit
13 Failure detection unit
14 Packet holding unit
15 Capture control unit
16 Parameter setting unit

1.-8. (canceled)

9. A packet capture method comprising:
receiving a packet;
dividing the packet and imparting a flag for each piece of data of the divided packet;
writing the data at an address of a ring buffer;
accumulating a number of bytes of the packet in response to the packet being received within a period for detecting a failure;
issuing a failure detection trigger in response to a cumulative value of the number of bytes exceeding a preset failure detection threshold value;
determining a writing stop address based on the failure detection trigger;
stopping writing to the ring buffer in response to writing to the ring buffer reaching or exceeding the writing stop address;
reading the data in order from the writing stop address;
determining a packet capture output based on the flag of the read data; and
executing the packet capture output depending on a result of determining the packet capture output.

10. The packet capture method according to claim 9, wherein the writing stop address is determined by going back in time series from a writing address at a time point at which the failure detection trigger is issued based on a preset address holding ratio at address of the ring buffer.

11. The packet capture method according to claim 10, further comprising:
determining whether the flag of the read data is a predetermined value; and
determining whether an end of the packet to which the read data belongs is lost.

12. The packet capture method according to claim 9, further comprising:
determining whether the flag of the read data is a predetermined value; and
determining whether an end of the packet to which the read data belongs is lost.

13. A packet capture device comprising:
one or more processors; and
a storage device storing a program to be executed by the one or more processors, the program including instructions for:
receiving a packet;
dividing the packet and imparting a flag for each piece of data of the divided packet;
writing the data into a ring buffer;
issuing a failure detection trigger in response to a failure being detected in reception of the packet;
stopping writing of the data based on the failure detection trigger; and
reading the data written in the ring buffer and outputting the data to a capture file based on the flag imparted to the data.

14. The packet capture device according to claim 13, wherein the program further includes instructions for issuing the failure detection trigger in response to a cumulative value of a number of bytes of the packet in a predetermined cycle exceeding a failure detection threshold value.

15. The packet capture device according to claim 14, wherein the program further includes instructions for:
calculating a writing stop address by tracing back in time series on the ring buffer from a writing address at a time point at which the failure detection trigger is issued based on a preset address holding ratio; and
stopping writing to the ring buffer in response to writing to the ring buffer reaching or exceeding the writing stop address.

16. The packet capture device according to claim 14, wherein the program further includes instructions for determining whether the flag is a predetermined value and determining whether an end of the packet to which the data belongs is lost.

17. The packet capture device according to claim 14, wherein the program further includes instructions for identifying a flow before detecting the failure.

18. The packet capture device according to claim 13, wherein the program further includes instructions for:
calculating a writing stop address by tracing back in time series on the ring buffer from a writing address at a time point at which the failure detection trigger is issued based on a preset address holding ratio; and
stopping writing to the ring buffer in response to writing to the ring buffer reaching or exceeding the writing stop address.

19. The packet capture device according to claim 18, wherein the program further includes instructions for determining whether the flag is a predetermined value and determining whether an end of the packet to which the data belongs is lost.

20. The packet capture device according to claim 18, wherein the program further includes instructions for identifying a flow before detecting the failure.

21. The packet capture device according to claim 13, wherein the program further includes instructions for determining whether the flag is a predetermined value and determining whether an end of the packet to which the data belongs is lost.

22. The packet capture device according to claim 21, wherein the program further includes instructions for identifying a flow before detecting the failure.

23. The packet capture device according to claim 13, wherein the program further includes instructions for identifying a flow before detecting the failure.
